(19) United States
(12) Patent Application Publication
(10) Pub. No.: US 2012/0136892 A1
(43) Pub. Date: May 31, 2012

(54) BOOK CONTENT DISTRIBUTION SYSTEM AND CONTENT SERVER

(75) Inventor: Yukinao Ajima, Tokyo (JP)

(73) Assignee: For-side.com Co., Ltd, Tokyo (JP)

(21) Appl. No.: 13/145,480

(22) PCT Filed: Sep. 24, 2010
(86) PCT No.: PCT/JP2010/066535

§ 371 Date: Jul. 20, 2011

(51) Int. Cl. G06F 17/30

(52) U.S. Cl. 707/769; 707/E17.014

(57) ABSTRACT

A content server retrieves a book content from a database in response to a book content search request, the book content meeting the book content search request transmitted from a user terminal; creates sample image data having a plurality of pages, with regard to the retrieved book content; and distributes search result information including the sample image data to the user terminal. The user terminal displays, when the search result information is received, a search result screen on which an image of a first page of a sample image of the book content is displayed as a thumbnail based on the sample image data of the book content; and, when a user provides a page-turning operation instruction to the sample image of the book content displayed on the search result screen, makes pages of the sample image turned page by page on the search result screen.

### CROSS REFERENCE TO RELATED APPLICATION

This application is entitled to the benefit of and incorporates by reference essential subject matter disclosed in International Patent Application No. PCT/JP2010/066535 filed on Sep. 24, 2010.

### FIELD OF THE INVENTION

The present invention relates to a book content distribution system and a content server.

### BACKGROUND OF THE INVENTION

Currently, there is known a technology by which contents retrieved and collected based on a keyword inputted from a user terminal via a network such as the Internet are displayed as a search result on a search result screen of the user terminal.

Furthermore, various methods for displaying a search result screen are proposed in order to improve the usability for users thereof. For example, Japanese Patent Application Laid-open Publication No. 2006-235760 discloses a method for displaying a search result screen, the method by which, on the search result screen where thumbnails are displayed as a search result, the length and the width of each of the thumbnails are adjusted so that a pseudo-depth is added to the search result screen.

### SUMMARY OF THE INVENTION

However, only small amount of information such as a title displayed in a thumbnail can be obtained from such a conventional search result screen described above with regard to each of contents.

In particular, when a searching target is a book content, only information such as the title, the author's name, and the like thereof can be obtained from a search result screen, with regard to each of book contents displayed thereon, and accordingly detailed information on the contents thereof cannot be obtained therefrom, which is not enough to stimulate users' interest.

In order to obtain the detailed information on each of the book contents displayed on the search result screen, for example, it is common to select a desired book content from among the book contents displayed on the search result screen, move to another site where the detailed information on the desired book content is described, and browses the site. However, it is troublesome to move to another site.

Objects of the present invention is to provide a book content distribution system and a content server in which detailed information on each of book contents which are obtained as a search result and displayed on a search result screen can be obtained from the search result screen.

To achieve at least one of the objects mentioned above, the present invention is a book content distribution system including: a content server; and a user terminal connected with the content server via a communication network, the content server including: a search database from which a book content is retrieved; a search unit to retrieve the book content from the search database in response to a book content search request, the book content meeting the book content search request transmitted from the user terminal; a sample image data creation unit to create sample image data having a plurality of pages, with regard to the book content retrieved by the search unit; and a search result information distribution unit to distribute search result information to the user terminal, the search result information including the sample image data created by the sample image data creation unit, and the user terminal including: a display unit to display, when the search result information distributed from the content server in response to the book content search request is received, a thumbnail screen on which an image of a first page of a sample image of the book content is displayed as a thumbnail based on the sample image data of the book content included in the search result information; and a first image control unit to make, when a user provides a page-turning operation instruction to the sample image of the book content displayed on the thumbnail screen as the thumbnail, pages of the sample image of the book content turned page by page on the thumbnail screen, the sample image to which the page-turning operation instruction is provided.

The present invention is a book content distribution system, wherein the user terminal further includes an enlargement display unit to display, when the user provides an enlargement instruction to the sample image of the book content displayed on the thumbnail screen as the thumbnail, an enlargement screen on which the sample image of the book content is enlarged and displayed, the sample image to which the enlargement instruction is provided, and when the user provides the page-turning operation instruction to the sample image of the book content enlarged and displayed on the enlargement screen, the first image control unit makes pages of the sample image of the book content turned page by page on the enlargement screen, the sample image to which the page-turning operation instruction is provided.

The present invention is a book content distribution system, wherein the user terminal further includes: a judgment unit to judge whether the page-turning operation instruction is provided within a preset prescribed period of time since the thumbnail screen or the enlargement screen is displayed; and a second image control unit to make the pages of the sample image of the book content turned page by page on the thumbnail screen or the enlargement screen based on a preset condition, when the page-turning operation instruction is not provided within the preset prescribed period of time.

The present invention is a book content distribution system, wherein the sample image data creation unit attaches a secondary content related to the book content, which is retrieved by the search unit, as attachment information to the sample image data, and when the page-turning operation instruction is provided to an image of the secondary content, the image which is based on the attachment information, the first image control unit makes pages of the image of the secondary content turned page by page on the thumbnail screen or the enlargement screen, the image to which the page-turning operation instruction is provided.

The present invention is a book content distribution system, wherein the content server further includes: a scrapbook creation unit to create a scrapbook of a plurality of the book contents in response to a scrapbook creation request transmitted from the user terminal, the scrapbook creation request requesting to create the scrapbook for sequentially replaying the sample images of the book contents as a batch; and a scrapbook distribution unit to distribute the scrapbook of the book contents to the user terminal, the scrapbook being created by the scrapbook creation unit, and the user terminal further includes: a scrapbook replay unit to replay the scrapbook when the scrapbook is received, the scrapbook being distributed from the content server in response to the scrapbook creation request.

The present invention is a content server connected with a user terminal via a communication network, the content server including: a search database from which a book content is retrieved; a search unit to retrieve a book content from the search database in response to a book content search request, the book content meeting the book content search request transmitted from the user terminal; a sample image data creation unit to create sample image data having a plurality of pages, with regard to the book content retrieved by the search unit; and a search result information distribution unit to distribute search result information to the user terminal, the search result information including the sample image data created by the sample image data creation unit.

According to an embodiment of the present invention, a content server retrieves a book content from a search database in response to a book content search request, the book content meeting the book content search request transmitted from a user terminal; creates sample image data having a plurality of pages, with regard to the retrieved book content; and distributes search result information including the sample image data to the user terminal.

In addition, the user terminal displays, when the search result information distributed from the content server is received, a thumbnail screen on which an image of a first page of a sample image of the book content is displayed as a thumbnail based on the sample image data of the book content included in the search result information; and, when a user provides a page-turning operation instruction to the sample image of the book content displayed on the thumbnail screen, makes pages of the sample image of the book content turned page by page on the thumbnail screen, the sample image to which the page-turning operation instruction is provided.

Accordingly, the pages of the sample image are turned on the thumbnail screen, which is a search result screen on which the book content obtained as a search result is displayed. Consequently, without moving from the thumbnail screen, the contents of its book can be looked at, and detailed information on the book content can be obtained.

### BRIEF DESCRIPTION OF THE DRAWINGS

FIG. 1 is a block diagram showing a book content distribution system of the present invention;

FIG. 2 is a block diagram showing a structure of an electronic content management server;

FIG. 3 is a conceptual diagram for explaining a structure of a database of the electronic content management server;

FIG. 4 is a block diagram showing a structure of a user terminal according to a first embodiment of the present invention;

FIG. 5 shows an example of a search result screen;

FIG. 6A is an illustration for explaining a page-turning operation on the search result screen;

FIG. 6B is an illustration for explaining the page-turning operation on the search result screen;

FIG. 6C is an illustration for explaining the page-turning operation on the search result screen;

FIG. 7 shows an example of an enlargement screen displayed on the search result screen;

FIG. 8A is an illustration for explaining the page-turning operation on the enlargement screen;

FIG. 8B is an illustration for explaining the page-turning operation on the enlargement screen;

FIG. 9 shows an example of a purchase site screen;

FIG. 10 shows an example of a state where a checkbox is displayed on the search result screen;

FIG. 11 shows an example of a batch replay screen;

FIG. 12 is a flow chart showing an operation of the book content distribution system according to the first embodiment;

FIG. 13 is a flow chart showing the operation of the book content distribution system according to the first embodiment;

FIG. 14 is a block diagram showing a structure of a user terminal according to a second embodiment of the present invention;

FIG. 15 shows an example of a search result screen;

FIG. 16 shows an example of an enlargement screen;

FIG. 17 is an illustration for explaining the page-turning operation on the enlargement screen;

FIG. 18A is an illustration for explaining the page-turning operation of a secondary content;

FIG. 18B is an illustration for explaining the page-turning operation of the secondary content;

FIG. 19 is a flow chart showing an operation of a book content distribution system according to the second embodiment; and

FIG. 20 is a flow chart showing the operation of the book content distribution system according to the second embodiment.

### DETAILED DESCRIPTION OF THE PREFERRED EMBODIMENTS

In the following, embodiments of the present invention are described in detail referring to the accompanying drawings. However, the scope of the present invention is not limited to the embodiments and the drawings.

### First Embodiment

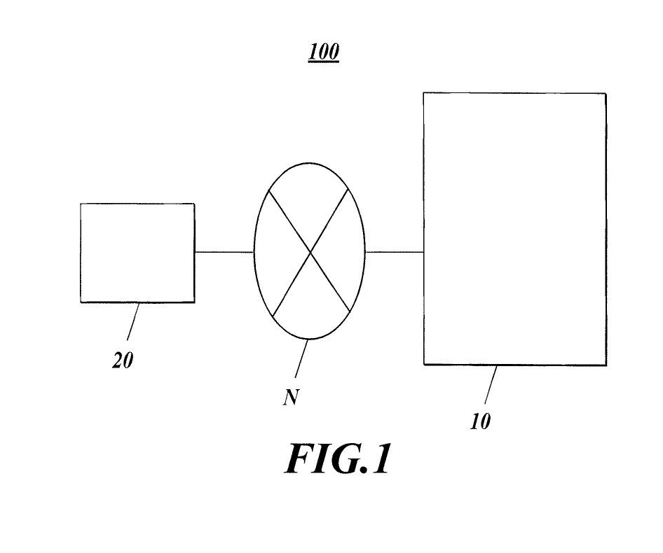

As shown in FIG. 1, a book content distribution system 100 includes a content server 10 and a user terminal 20.

### (Content Server)

The content server 10 is managed and run by, for example, a service provider (not shown) which is an electronic content distributor.

The service provider receives book contents provided from authors and/or publishers, and provides information thereon to users.

More specifically, the service provider has a function to distribute book contents to the users, the book contents which are created by digitizing contents of books provided from the authors and/or the publishers, and also has a function to run a book search site (homepage), and the like.

That is, in order to achieve such functions of the service provider, the service provider includes the content server 10 or the like which stores the book contents so that the content server 10 functions as a searching area.

The book contents are digitized contents of books including novels, newspapers, and magazines. For example, a book content is an electronic content created in a data format of a text or a text to which composition information is attached.

Furthermore, a secondary content can be attached to a book content, the secondary content which includes a comment such as a review and/or an opinion related to the book content, and a rank of the book content.

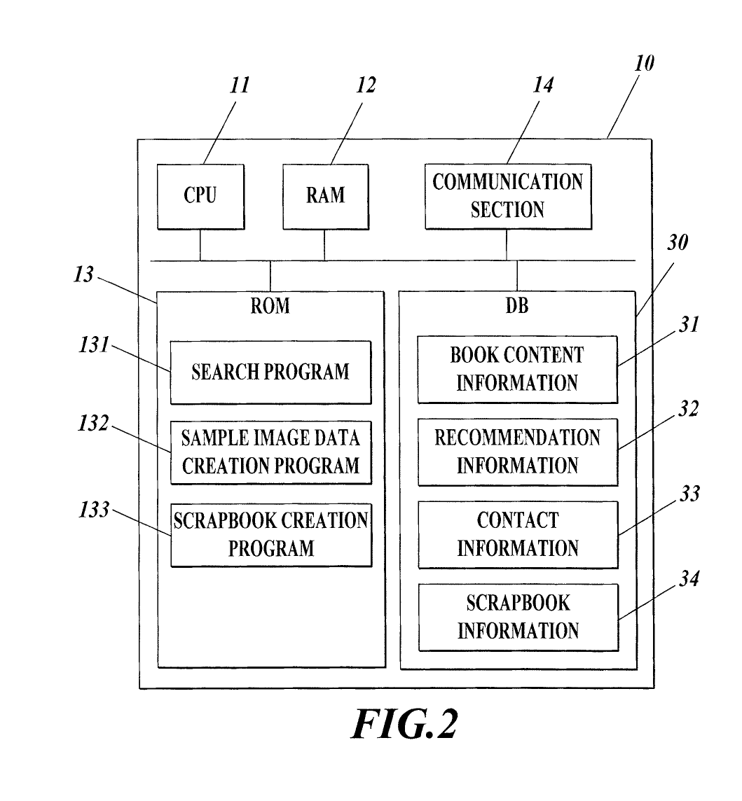

As shown in FIG. 2, the content server 10 includes a CPU (Central Processing Unit) 11, a RAM (Random Access Memory) 12, a ROM (Read Only Memory) 13, a communication section 14, and a database 30, and is connected to a communication network N by a communication interface (not shown).

Here, the structure of the database 30 is described.

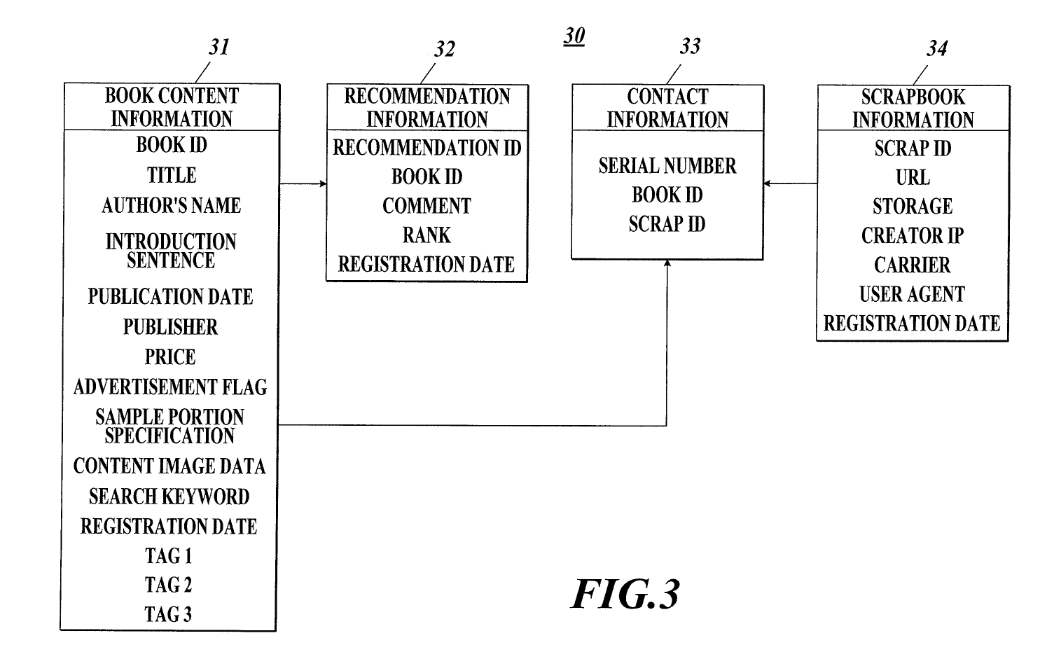

As shown in FIGS. 2 and 3, book content information 31, recommendation information 32, contact information 33, scrapbook information 34, and the like are stored in the database 30.

The book content information 31 is information on book contents distributed to the user terminal 20.

The book content information 31 includes a book ID, a title, an author's name, an introduction sentence, a publication date, a publisher, a price, an advertisement flag, a sample portion specification, content image data, a search keyword, a registration date, a tag 1, a tag 2, and a tag 3.

The book content information 31 functions as a search database to search for and retrieve book contents.

The recommendation information 32 is information which connects information on secondary contents attached to their respective book contents with the book content information 31.

The recommendation information 32 includes a recommendation ID, the book ID, the comment, the rank, and the registration date, and is correlated with the book content information 31 via the book ID.

The contact information 33 includes a serial number, the book ID, and a scrap ID.

The contact information 33 is correlated with the book content information 31 via the book ID, and correlated with the scrapbook information 34 via the scrap ID.

The scrapbook information 34 includes the scrap ID, a URL, a storage, a creator IP, a carrier, a user agent, and the registration date.

The CPU 11 performs various control processing according to various processing programs stored in the ROM 13, for example.

The RAM 12 forms a work memory area which stores data on which arithmetic processing is performed by the CPU 11.

The ROM 13 stores a system program executable by the CPU 11, the various processing programs executable by the system program, data used when the various processing programs are executed, data of results of the various processing, the data on which the arithmetic processing is performed by the CPU 11, and the like. The programs are stored in the ROM 13 in a form of program codes which can be read by computers.

More specifically, the ROM 13 stores a search program 131, a sample image data creation program 132, a scrapbook creation program 133, and the like.

The search program 131 allows the CPU 11 to activate a function to retrieve book contents from the book content information 31 in response to the book content search request, the book contents which meet the book content search request transmitted from the user terminal 20, for example.

More specifically, when the book content search request which requests to retrieve book contents meeting a specific keyword is transmitted from the user terminal 20, the CPU 11 refers to search keywords in the book content information 31, and searches for a book ID of which a search keyword meets the specific keyword. Then, the CPU 11 judges that a book content having the book ID of which the search keyword meets the specific keyword is the book content which meets the book content search request so as to retrieve the book content.

The CPI 11 functions as a search unit by executing the search program 131.

The sample image data creation program 132 allows the CPU 11 to activate a function to create sample image data having a plurality of pages, with regard to each of the book contents retrieved by executing the search program 131, for example.

More specifically, the CPU 11 executes the sample image data creation program 132, and thereby creates the sample image data by extracting a portion of content image data of a book content in the book content information 31, the portion which is specified as a sample portion, with regard to each of the book contents which meet the book content search request.

The sample image data has a plurality of pages, and is created by extracting only a certain portion specified as a sample portion (sample portion specification) from the content image data of a book content.

The sample portion specification is performed, for example, by the service provider or the like, and the service provider or the like can selectively specify a certain portion of the content image data of a book content, the portion which is desired to be displayed on a thumbnail screen G1 (described below) of the user terminal 20.

Not text-only information or a one-page-only still image but the sample image having a plurality of pages, the sample image of which pages are turned page by page (page-turning operation), is displayed on the thumbnail screen G1 of the user terminal 20 based on the sample image data.

The CPU 11 attaches a secondary content related to each of the retrieved book contents to the sample image data as attachment information by executing the sample image data creation program 132.

More specifically, the CPU 11 refers to the book ID in the recommendation information 32, and when there is a secondary content related to a book content which meets the book content search request, the CPU 11 attaches the secondary content as the attachment information to the sample image data based on the recommendation information 32.

The image of a secondary content is also displayed on the thumbnail screen G1 of the user terminal 20 based on the attachment information.

The CPU 11 functions as a sample image data creation unit by executing the sample image data creation program 132.

The scrapbook creation program 133 allows the CPU 11 to activate a function to create a scrapbook with regard to a plurality of book contents in response to the scrapbook creation request transmitted from the user terminal 20, for example. The scrapbook creation request is to request to create a scrapbook by which the sample images of book contents are sequentially replayed as a batch.

More specifically, when the scrapbook creation request is transmitted from the user terminal 20, the CPU 11 creates the sample image data with regard to each of the book contents which are specified by the scrapbook creation request. The CPU 11, then, gives one scrap ID to a set of the created sample image data of the book contents regarding as one scrapbook, and stores information on the created scrapbook in the scrapbook information 34.

Based on the data of the scrapbook, the scrapbook is displayed on a batch replay screen G4 (described below) of the user terminal 20, the scrapbook in which the page-turning operation is sequentially performed on the sample images of the book contents.

An unspecified large number of users can share the scrapbook by storing the created scrapbook in the database 30 and by adding a URL thereto. The added URL is stored in the scrapbook information 34.

The created scrapbook can be created as an electronic book by encoding so as to be looked at from arbitrary electronic terminals. The created electronic book is stored in the database 30.

The CPU 11 functions as a scrapbook creation unit by executing the scrapbook creation program 133.

The communication section 14 distributes, as a search result information distribution unit, search result information including the sample image data, which is created by executing the sample image data creation program 132, to the user terminal 20.

The communication section 14 distributes, as a scrapbook distribution unit, a scrapbook of book contents, the scrapbook which is created by executing the scrapbook creation program 133, to the user terminal 20.

### (User Terminal)

The user terminal 20 is a device which can replay book contents obtained from the content server 10 so that the book contents are looked at (read). A user can obtain desired book contents by accessing the content server 10 with the user terminal 20, the content server 10 which is managed and run by an electronic content distributor.

In the embodiment, a personal computer is used as the user terminal 20.

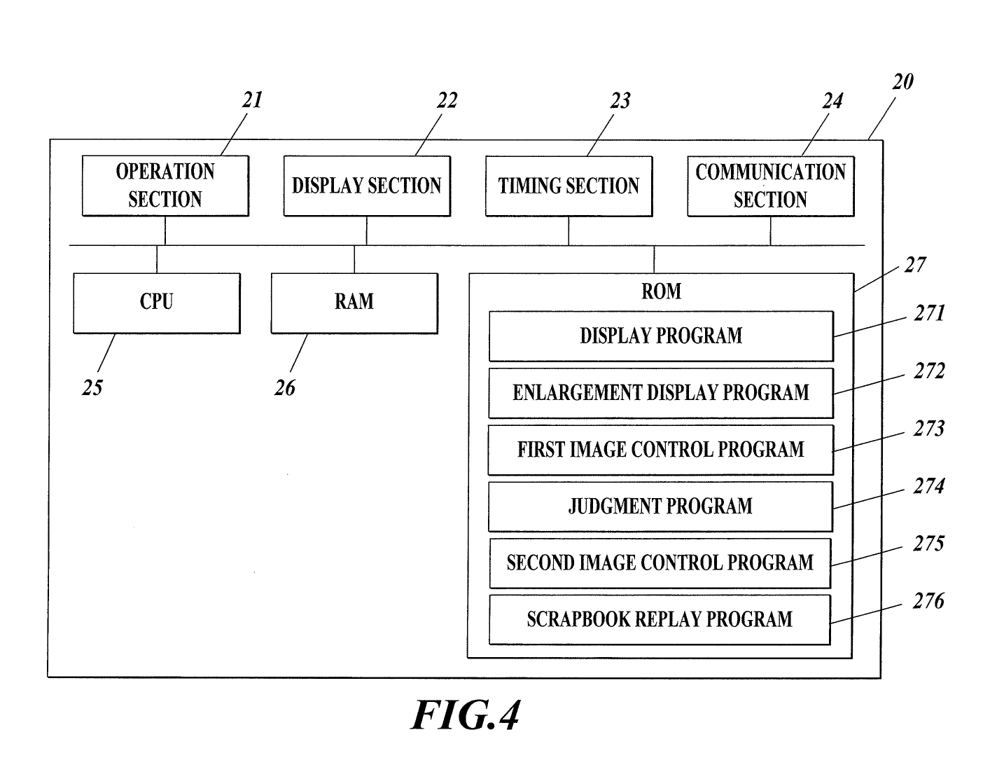

More specifically, as shown in FIG. 4, the user terminal 20 includes an operation section 21, a display section 22, a timing section 23, a communication section 24, a CPU 25, a RAM 26, and a ROM 27.

The operation section 21 is composed of, for example, a keyboard which includes cursor keys, number input keys, and various function keys. The operation section 21 outputs a signal to the CPU 25 in response to a user operation.

For example, the operation section 21 is operated when the user instructs to turn pages (page-tuning operation instruction) of the sample image of a book content which is displayed as a thumbnail on the thumbnail screen G1.

The operation section 21 is also operated when the user instructs to enlarge (enlargement instruction) the sample image of a book content which is displayed on the thumbnail screen G1 as a thumbnail.

In addition, the operation section 21 is operated when a search by using an arbitrary keyword (search operation) is performed, and when a selection operation to select a plurality of book contents which form a scrapbook (described below) is performed, for example.

The display section 22 is composed of, for example, an LCD (Liquid Crystal Display), and displays various screens such as the thumbnail screen G1, an enlargement screen G2 displayed on the thumbnail screen G1 by launching a new window, a purchase site screen G3, and a batch replay screen G4, for example.

The thumbnail screen G1 is a search result screen on which the image of the first page of the sample image of a book content distributed from the content server 10 in response to the book content search request is displayed as a thumbnail.

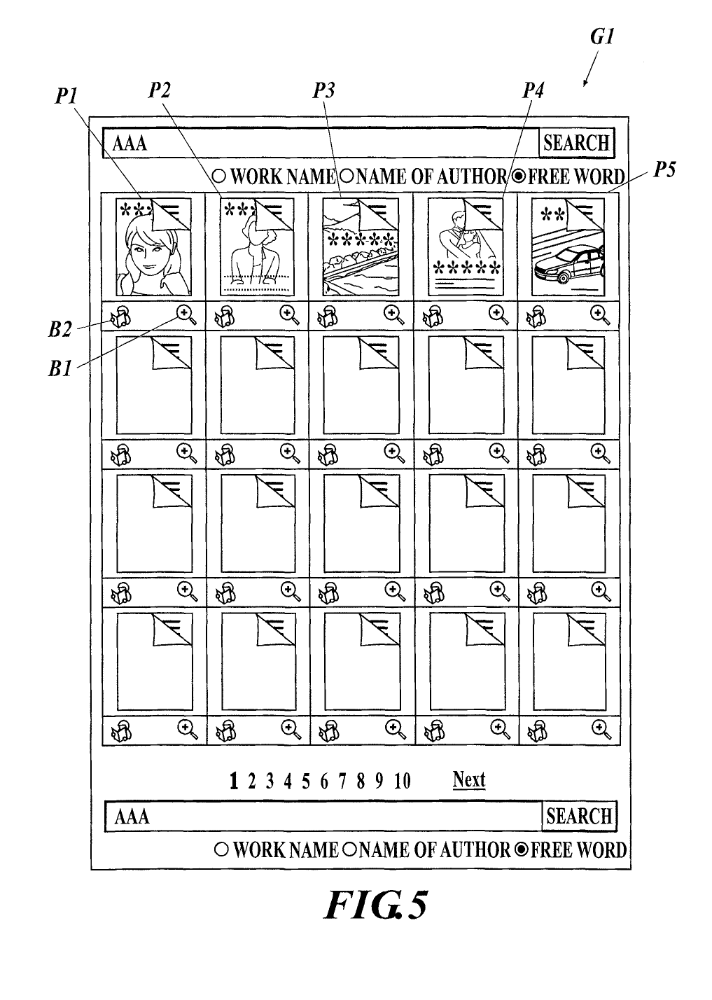

More specifically, as shown in FIG. 5, for example, 20 frames are disposed on the thumbnail screen G1 so that thumbnails of 20 book contents are displayed at the maximum. Thereby, the first page (front page) of the sample image of each book content distributed from the content server 10 is displayed as a thumbnail in a frame. When the number of the book contents distributed from the content server 10 is less than 20, the surplus frames are displayed without thumbnails therein. On the other hand, when the number of the book contents distributed from the content server 10 is more than 20, the thumbnail screen G1 having a plurality of screen pages changes its screen page from the currently displayed screen page to its next screen page.

FIG. 5 shows an example of sample images P1 to P5 of five book contents displayed as thumbnails.

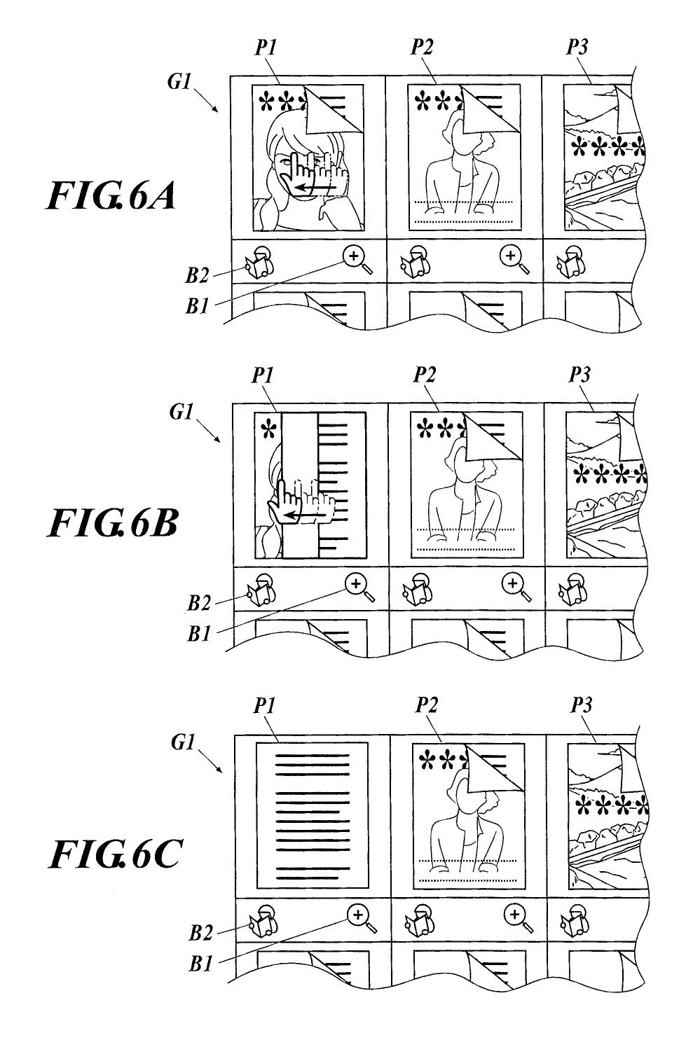

On the thumbnail screen G1, the right-top corner part of each thumbnail is always flapping as if a wind is blowing, by which the user can recognize that the page-turning operation instruction can be provided to the image. When the user drags the image with a pointer as the page-turning operation instruction (FIG. 6A), the first (front) page of the thumbnail is gradually turned (FIG. 6B), and the second page thereof in which the contents of its book are described appears (FIG. 6C).

In the embodiment, when no page-turning operation instruction is provided by the user within a preset prescribed period of time since the thumbnail screen G1 is displayed on the display section 22, the page-turning operation described above referring to FIGS. 6A to 6C is automatically performed based on a preset condition.

By the “preset condition”, for example, the followings are defined: on which sample image/images among sample images displayed on the thumbnail screen G1 the page-turning operation is performed; at what speed the page-turning operation is performed; and in what order of the sample images the page-turning operation is performed. The condition is set by the user in advance.

More specifically, for example, the followings can be set by the preset condition: the page-turning operation is sequentially performed on from the top-left thumbnail to the bottom-right thumbnail on the thumbnail screen G1 at a constant speed; and the page-turning operation is simultaneously performed on all the thumbnails on the thumbnail screen G1 at a constant speed.

Each thumbnail is provided with an enlargement button B1 which receives the enlargement instruction for the image, and a purchase site moving button B2 which receives an instruction to move to a purchase site.

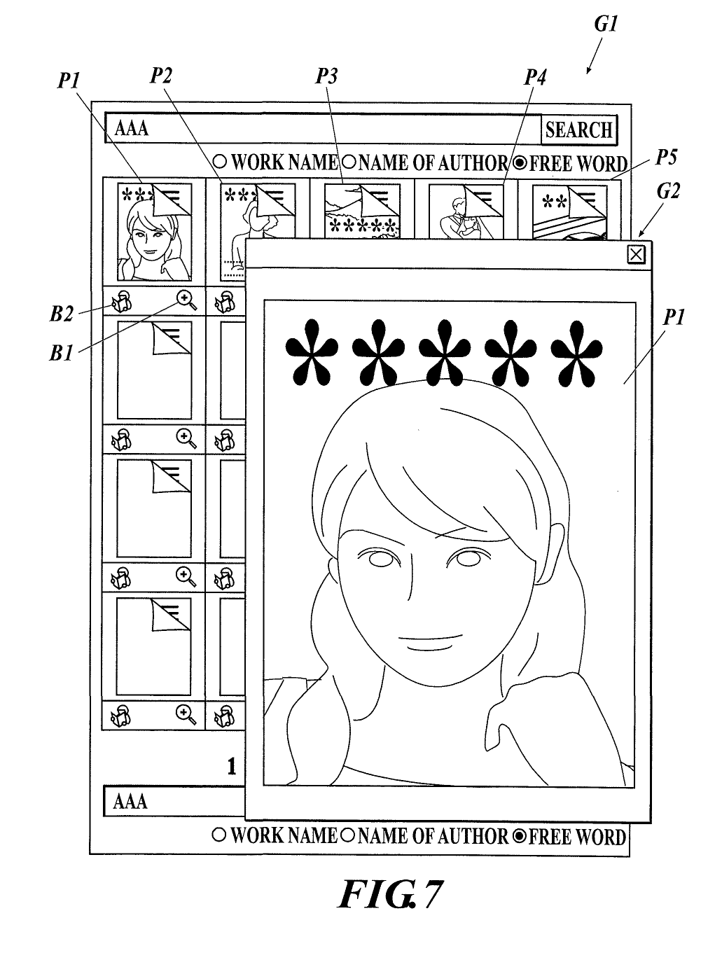

When the enlargement button B1 is operated, as shown in FIG. 7, the enlargement screen G2 is displayed on the thumbnail screen G1 by launching a new window. On the enlargement screen G2, a thumbnail enlarged by operating the enlargement button B1 is displayed.

FIG. 7 shows an example of the image P1 enlarged and displayed on the enlargement screen G2 by operating the enlargement button B1.

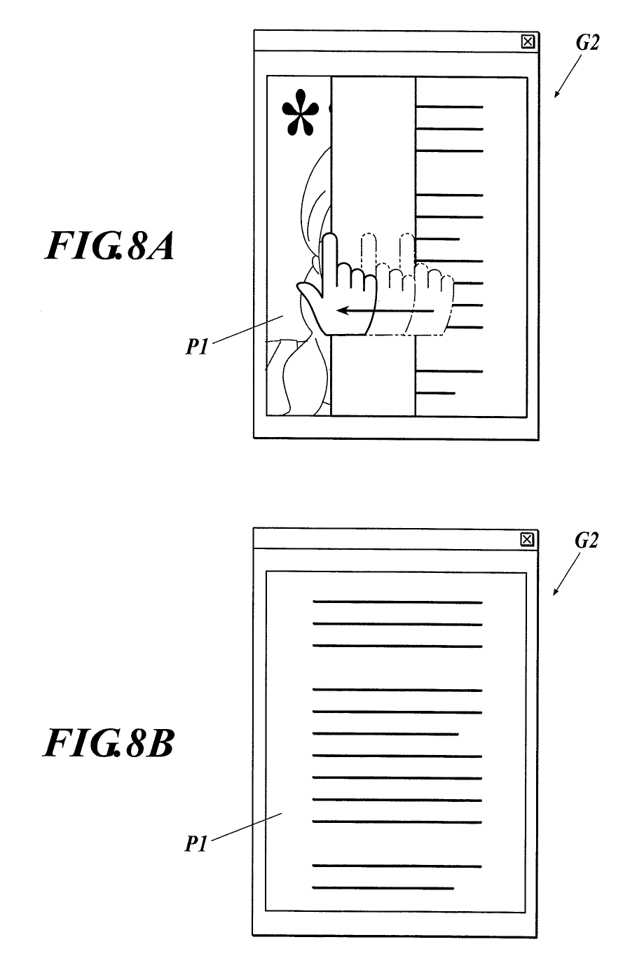

Pages of the enlarged image displayed on the enlargement screen G2 can also be turned (FIG. 8A) in response to a user operation, so that the next page thereof can be displayed (FIG. 8B).

When no page-turning operation instruction is provided by the user within a preset prescribed period of time since the enlargement screen G2 is displayed, the page-turning operation shown in FIGS. 8A and 8B is automatically performed based on a preset condition.

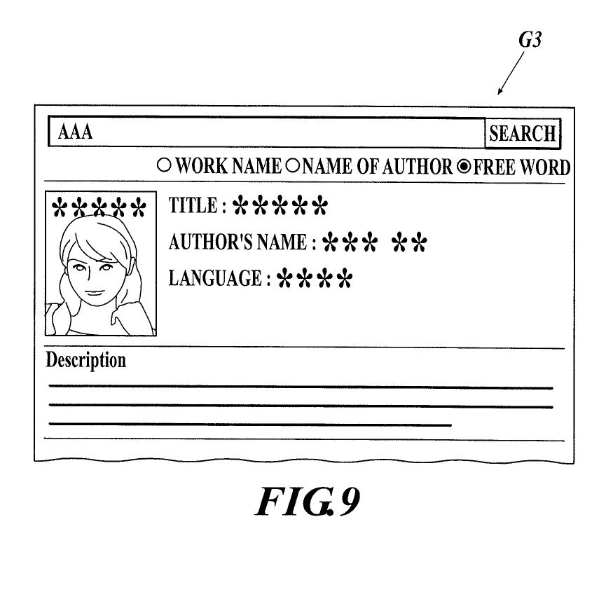

In addition, when the purchase site moving button B2 is operated, the thumbnail screen G1 is changed to the purchase site screen G3 shown in FIG. 9, which is a link destination. On the purchase site screen G3, detailed information on a book content of which the purchase site moving button B2 of the thumbnail is operated is described. The detailed information includes the title, the author's name, a description, and the like. The user can examine the contents of its book, and purchase the book on the purchase site screen G3.

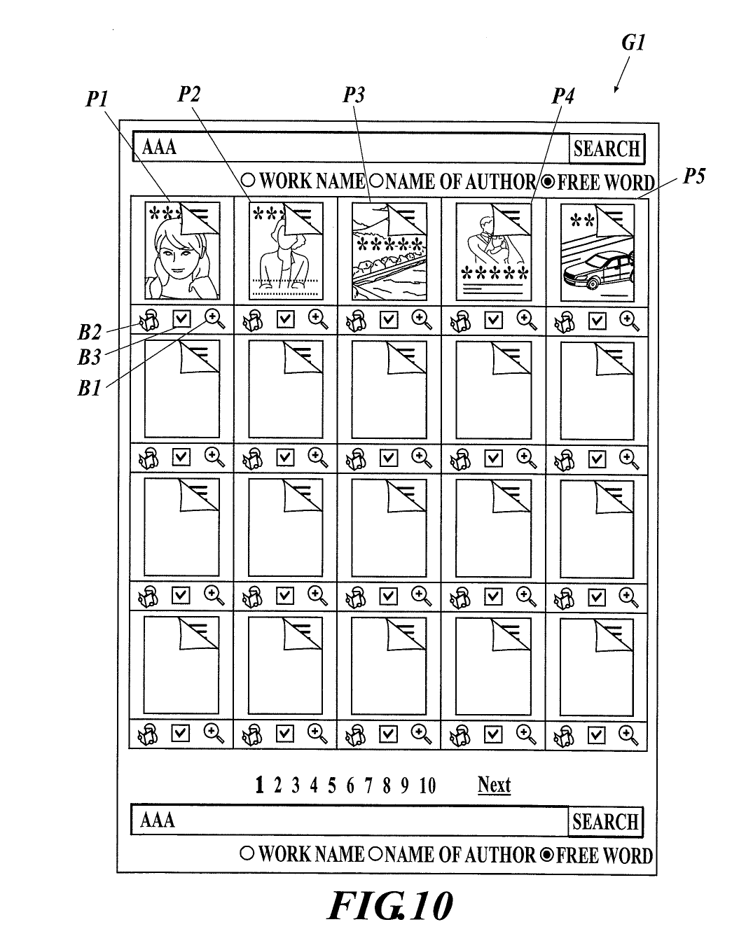

On the thumbnail screen G1, a checkbox B3 for each thumbnail can be displayed as shown in FIG. 10 by operating a checkbox display button (not shown).

The user uses the checkboxes B3 to select book contents of which the user desires to replay the sample images as a batch.

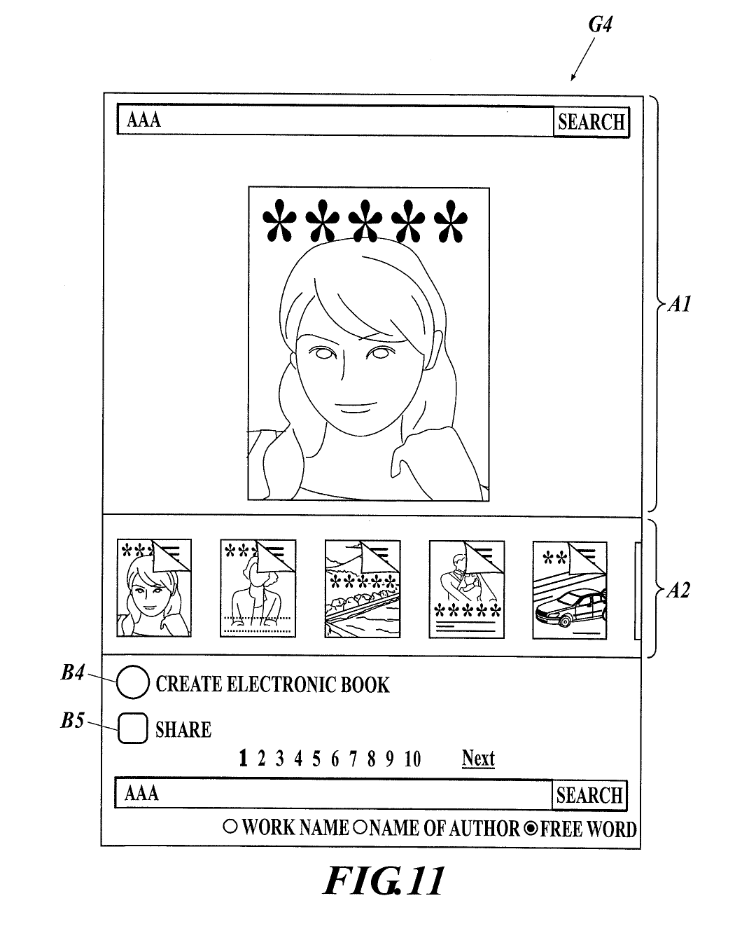

More specifically, when the user checks the checkboxes B3 of desired thumbnails, and operates an execution button (not shown), the thumbnail screen G1 is changed to the batch replay screen G4 shown in FIG. 11, for example.

The batch replay screen G4 is provided with a replay area A1, a sample display area A2, an electronic book creation button B4, a sharing button B5, and the like.

In the replay area A1, the page-turning operation is sequentially performed on the sample images of the book contents, the book contents of which the thumbnails are selected. Consequently, the user can look at the contents of a plurality of books at a time.

In the sample image area A2, the selected thumbnails are displayed. Consequently, the user can confirm which book contents the user selects at a glance.

The electronic book creation button B4 is used for making the book contents of the selected thumbnails one electronic book.

The sharing button B5 is used for sharing the book contents of the selected thumbnails with another user.

The timing section 23 is a timer to measure a time from a time measurement starting point to a time measurement ending point based on a control signal from the CPU 11. The time measurement starting point is a time when the thumbnail screen G1 or the enlargement screen G2 is displayed on the display section 22, and the time measurement ending point is a time when the user provides the page-turning operation instruction or when a preset prescribed period of time elapses.

The communication section 24 transmits the book content search request to the content server 10, and receives the search result information distributed from the content server 10 in response to the book content search request, for example.

The communication section 24 also transmits the scrapbook creation request to create a scrapbook of a plurality of book to the content server 10, and receives the scrapbook distributed from the content server 10 in response to the scrapbook creation request, for example.

The CPU 25 performs various control processing according to various processing programs stored in the ROM 27, for example.

More specifically, the CPU 25 reads, as needed, an application program such as an electronic book viewer stored in the ROM 27, and expands the application in the RAM 26 so as to execute the application. Consequently, the CPU 25 changes display on the display section 22 in response to an operation to the operation section 21, for example.

The RAM 26 forms a work memory area where data on which arithmetic processing is performed by the CPU 25 is stored.

The ROM 27 stores, for example, a system program executable by the CPU 25, the various processing programs executable by the system program, data used to execute the various processing programs, data of results of the various processing, the data on which the arithmetic processing is performed by the CPU 25, and the like. The programs are stored in the ROM 27 in a form of program codes which can be read by computers.

More specifically, the ROM 27 stores, for example, a display program 271, an enlargement display program 272, a first image control program 273, a judgment program 274, a second image control program 275, and a scrapbook replay program 276.

The display program 271 allows the CPU 25 to activate a function to display the thumbnail screen G1 on which the image of the first page of the sample image of a book content is displayed as a thumbnail based on the sample image data of the book content included in the search result information when the search result information distributed from the content server 10 in response to the book content search request is received, for example.

More specifically, when the search result information distributed from the content server is received, the CPU 25 executes the display program 271, and thereby displays the thumbnail screen G1 as the search result screen on the display section 22 (FIG. 5).

At this point, when the attachment information is attached to the sample image data included in the received search result information, the CPU 25 also displays the image of a secondary content based on the attachment information.

The CPU 25 functions as a display unit with the display section 22 by executing the display program 271.

The enlargement display program 272 allows the CPU 25, when the user provides the enlargement instruction to the sample image of a book content displayed as a thumbnail on the thumbnail screen G1, to activate a function to display the enlargement screen G2 on which the sample image displayed as a thumbnail on the thumbnail screen G1 of the book content is enlarged so as to be displayed as an enlarged image, the sample image to which the enlargement instruction is provided, for example.

More specifically, when the user operates the enlargement button B1 which is provided with each thumbnail on the thumbnail screen G1, the CPU 25 executes the enlargement display program 272, and thereby displays the enlargement screen G2 on the thumbnail screen G1 in such a way that the enlargement screen G2 overlaps the thumbnail screen G1 (FIG. 7).

At this point, the CPU 25 communicates with the content server 10, and if there is page information which is not obtained by the CPU 25 yet in the book content information 31 of the database 30, the page information such as a large size image for the enlargement and other detailed information, the CPU 25 obtains the page information therefrom.

The CPU 25 functions as an enlargement display unit with the display section 22 by executing the enlargement display program 272.

The first image control program 273 allows the CPU 25 to activate a function to turn pages of the sample image of a book content page by page on the thumbnail screen G1 or the enlargement screen G2, the sample image to which the page-turning operation instruction is provided, when the user provides the page-turning operation instruction to the sample image of the book content displayed as a thumbnail on the thumbnail screen G1 or displayed as an enlarged image on the enlargement screen G2, for example.

More specifically, when the user provides the page-turning operation instruction to any of thumbnails on the thumbnail screen G1, the CPU 25 executes the first image control program 273, and thereby makes pages of the sample image displayed as a thumbnail turned so as to display the next page to the currently displayed page thereof on the thumbnail screen G1 in response to the page-turning operation instruction, the thumbnail to which the page-turning operation instruction is provided (FIGS. 6A to 6C).

Furthermore, when the user provides the page-turning operation instruction to an enlarged image on the enlargement screen G2, the CPU 25 executes the first image control program 273, and thereby makes pages of the sample image displayed as the enlarged image turned so as to display the next page to the currently displayed page thereof on the enlargement screen G2 in response to the page-turning operation instruction, the enlarged image to which the page-turning operation instruction is provided (FIGS. 8A and 8B).

When the page-turning operation instruction is provided to the image of a secondary content, the CPU 25 also executes the first image control program 273, and thereby makes pages of the image of the secondary content turned page by page on the thumbnail screen G1 or the enlargement screen G2, the image to which the page-turning operation instruction is provided.

At this point, the CPU 25 communicates with the content server 10, and obtains the page information which is not obtained by the CPU 25 yet from the book content information 31 and/or the recommendation information 32 of the database 30.

The CPU 25 functions as a first image control unit by executing the first image control program 273.

The judgment program 274 allows the CPU 25 to activate a function to judge whether the page-turning operation instruction is provided within a preset prescribed period of time since the thumbnail screen G1 or the enlargement screen G2 is displayed, for example.

More specifically, the CPU 25 allows the timing section 23 to measure a time from the time measurement starting point which is a time when the thumbnail screen G1 is displayed on the display section 22, and continues measuring the time unless the page-turning operation instruction is provided. When a preset prescribed period of time elapses before the page-turning operation instruction is provided, an instruction signal which instructs to automatically perform the page-turning operation is outputted.

The CPU 25 also allows the timing section 23 to measure a time from the time measurement starting point which is a time when the enlargement screen G2 is displayed on the display section 22, and continues measuring the time unless the page-turning operation instruction is provided. When a preset prescribed period of time elapses before the page-turning operation instruction is provided, an instruction signal which instructs to automatically perform the page-turning operation is outputted.

The CPU 25 functions as a judgment unit by executing the judgment program 274.

The second image control program 275 allows the CPU 25 to activate a function to turn pages of the sample image of a book content page by page on the thumbnail screen G1 or the enlargement screen G2 based on a preset condition when it is judged by executing the judgment program 274 that the page-turning operation instruction is not provided, for example.

More specifically, the CPU 25 performs the page-turning operation on the sample image of a book content on the thumbnail screen G1 based on a preset condition in response to an instruction signal which instructs to automatically perform the page-turning operation (FIGS. 6A to 6C).

Similarly, the CPU 25 performs the page-turning operation on the sample image of a book content on the enlargement screen G2 based on a preset condition in response to an instruction signal which instructs to automatically perform the page-turning operation (FIGS. 8A and 8B).

The CPU 25 functions as a second image control unit by executing the second image control program 275.

The scrapbook replay program 276 allows the CPU 25 to activate a function to replay a scrapbook when the scrapbook distributed from the content server 10 in response to the scrapbook creation request is received, for example.

At this point, first, the user selects, by using the checkboxes B3 on the thumbnail screen G1, thumbnails of book contents of which the user desires to replay the sample images as a batch (FIG. 10), and the scrapbook creation request is transmitted to the content server 10.

Next, the CPU 25 receives a scrapbook created at and transmitted from the content server 10, executes the scrapbook replay program 276, and thereby allows the display section 22 to display the scrapbook on the batch replay screen G4 so as to replay the scrapbook (FIG. 11).

Consequently, the sample images of the book contents selected by using the checkboxes B3 on the thumbnail screen G1 are sequentially replayed.

The CPU 25 functions as a scrapbook replay unit by executing the scrapbook replay program 276.

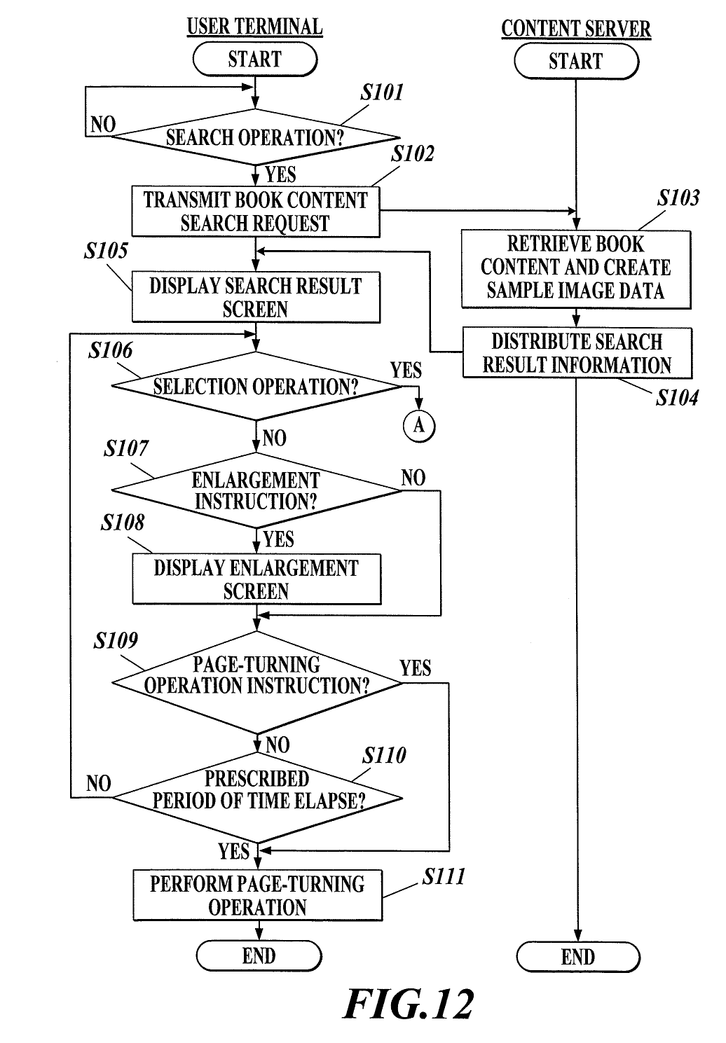

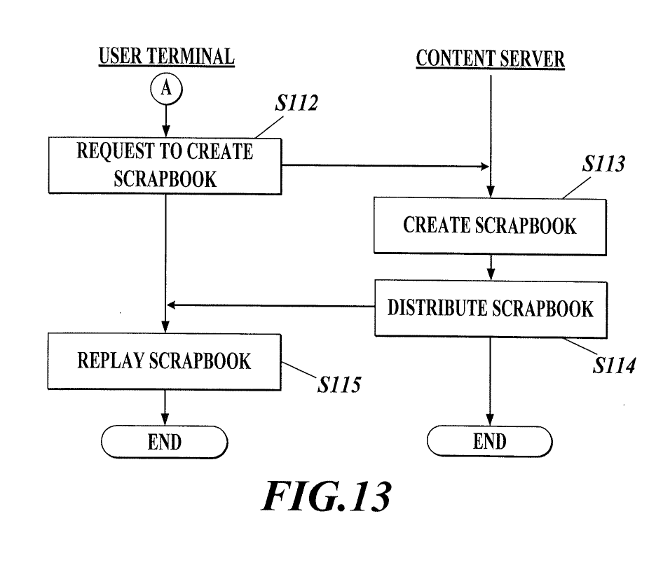

Next, an operation of the book content distribution system 100 at the time of a book content search is described referring to FIGS. 12 and 13.

First, at Step S101, the CPU 25 of the user terminal 20 judges whether the search operation is performed from the operation section 21. When it is judged that the search operation is not performed (Step S101: NO), the CPU 25 repeats Step S101. When it is judged that the search operation is performed (Step S101: YES), the CPU 25 transmits the book content search request to the content server 10 at the following Step S102.

Next, at Step S103, the CPU 11 of the content server 10 retrieves book contents by using the book content information 31 of the database 30, and creates the sample image data with regard to each of the retrieved book contents.

Then, at Step S104, the CPU 11 of the content server 10 distributes the search result information including the sample image data to the user terminal 20.

At Step S105, the CPU 25 of the user terminal 20 displays the thumbnail screen G1 on the display section 22.

Next, at Step S106, the CPU 25 of the user terminal 20 judges whether the selection operation to select the sample images of the book contents which are desired to be replayed as a batch is performed. When it is judged that the selection operation is performed (Step S106: YES), the CPU 25 moves to Step S112 described below.

On the other hand, when it is judged that the selection operation is not performed (Step S106: NO), the CPU 25 of the user terminal 20 judges whether the enlargement instruction is provided to a sample image from the operation section 21 at the following Step S107. When it is judged that the enlargement instruction is not provided (Step S107: NO), the CPU 25 moves to Step S109 described below.

On the other hand, when it is judged that the enlargement instruction is provided (Step S107: YES), the CPU 25 of the user terminal 20 displays the enlargement screen G2 on the thumbnail screen G1 at the following Step S108.

Next, at Step S109, the CPU 25 of the user terminal 20 judges whether the page-turning operation instruction is provided from the operation section 21. When it is judged that the page-turning operation instruction is provided (Step S109: YES), the CPU 25 moves to the Step S111 described below.

On the other hand, when it is judged that the page-turning operation instruction is not provided (Step S109: NO), the CPU 25 of the user terminal 20 judges whether the prescribed period of time elapses at the following Step S110. When it is judged that the prescribed period of time does not elapse (Step S110: NO), the CPU 25 returns to Step S106, and repeats the following steps.

On the other hand, when it is judged that the prescribed period of time elapses (Step S110: YES), the CPU 25 of the user terminal 20 moves to the following Step S111.

At Step S111, the CPU 25 of the user terminal 20 performs the page-turning operation.

When the selection operation is performed at the above-described Step S106 (Step S106: YES), the CPU 25 of the user terminal 20 transmits the scrapbook creation request to the content server 10 at the following Step S112.

Next, at Step S113, the CPU 11 of the content server 10 creates the scrapbook data.

Then, at Step S114, the CPU 11 of the content server 10 distributes the created scrapbook to the user terminal 20.

Next, at Step S115, the CPU 25 of the user terminal 20 replays the scrapbook.

As described above, according to the embodiment, the content server 10 retrieves a book content from the book content information 31 in response to the book content search request, the book content meeting the book content search request transmitted from the user terminal 20; creates the sample image data having a plurality of pages, with regard to the retrieved book content; and distributes the search result information including the sample image data to the user terminal 20.

In addition, the user terminal 20 displays, when the search result information distributed from the content server 10 is received, the thumbnail screen G1 on which the image of the first page of the sample image of the book content is displayed as a thumbnail based on the sample image data of the book content included in the search result information; and, when a user provides the page-turning operation instruction to the sample image of the book content displayed on the thumbnail screen G1, makes pages of the sample image of the book content turned page by page on the thumbnail screen G1, the sample image to which the page-turning operation instruction is provided.

Accordingly, the pages of the sample image are turned on the thumbnail screen G1, which is the search result screen on which the book content obtained as a search result is displayed. Consequently, without moving from the thumbnail screen G1, the contents of its book can be looked at, and detailed information on the book content can be obtained.

According to the embodiment, when the user provides the enlargement instruction to the sample image of the book content displayed on the thumbnail screen G1 as the thumbnail, the user terminal 20 displays the enlargement screen G2 on which the sample image of the book content is enlarged and displayed, the sample image to which the enlargement instruction is provided; and when the user provides the page-turning operation instruction to the sample image of the book content enlarged and displayed on the enlargement screen G2, the user terminal 20 makes the pages of the sample image of the book content turned page by page on the enlargement screen G2, the sample image to which the page-turning operation instruction is provided.

Accordingly, by enlarging a desired image, the contents of its book can be looked at, and hence the user can easily examine the contents of the book.

According to the embodiment, the user terminal 20 judges whether the page-turning operation instruction is provided within a preset prescribed period of time since the thumbnail screen G1 or the enlargement screen G2 is displayed, and makes the pages of the sample image of the book content turned page by page on the thumbnail screen G1 or the enlargement screen G2 based on a preset condition when the page-turning operation instruction is not provided within the preset prescribed period of time.

Accordingly, the page-turning operation is performed on the sample image on the thumbnail screen G1 without a user operation, and hence, the visual effect of the thumbnail screen G1 is high, so that consumer appetite of the user can be increased.

According to the embodiment, the content server 10 attaches a secondary content related to the book content as the attachment information to the sample image data, and when the page-turning operation instruction is provided to the image of the secondary content, the image which is based on the attachment information, the user terminal 20 makes pages of the image of the secondary content turned page by page on the thumbnail screen G1 or the enlargement screen G2, the image to which the page-turning operation instruction is provided.

Accordingly, the pages of the image of the secondary content are turned on the thumbnail screen G1 or the enlargement screen G2. Consequently, without moving from the thumbnail screen G1 or the enlargement screen G2, the contents thereof can be looked at, and detailed information on the book content can be obtained.

According to the embodiment, the content server 10 creates a scrapbook of a plurality of the book contents in response to the scrapbook creation request transmitted from the user terminal 20, the scrapbook creation request requesting to create the scrapbook for sequentially replaying the sample images of the book contents as a batch; and distributes the scrapbook to the user terminal 20, and the user terminal 20 replays the scrapbook when the scrapbook is received, the scrapbook being distributed from the content server 10.

Accordingly, the user can look at the contents of a plurality of desired book at a time, and hence, the usability for the user can be improved.

In the above-described embodiment, each of the thumbnail screen G1 and the enlargement screen G2 is displayed so as to cover almost the whole surface of the display section 22. However, each of the thumbnail screen G1 and the enlargement screen G2 may be displayed on a part of the surface of the display section 22.

In such a manner, the book content distribution system 100 can be used for a web widget, search advertising, and contexual advertising, for example.

### Second Embodiment

Next, a second embodiment of the present invention is described centering on difference points from the first embodiment thereof.

For the sections and the like of the present invention according to the second embodiment, the sections and the like which are shared with the first embodiment, the same reference numerals are attached thereto, and the explanation thereof is omitted.

A book content distribution system (not shown) according to the second embodiment includes the content sever 10 and a user terminal 20A.

The user terminal 20A is composed of, for example, a small-sized information terminal device such as a cell phone.

Since a display section 22A of such a user terminal 20A is smaller than the display section 22 of the user terminal 20, in the user terminal 20A, it is not easy to perform the page-turning operation on a thumbnail screen. Accordingly, in the second embodiment, as a suitable control to the user terminal 20A, a part of a thumbnail screen is enlarged, and the page-turning operation is performed thereon.

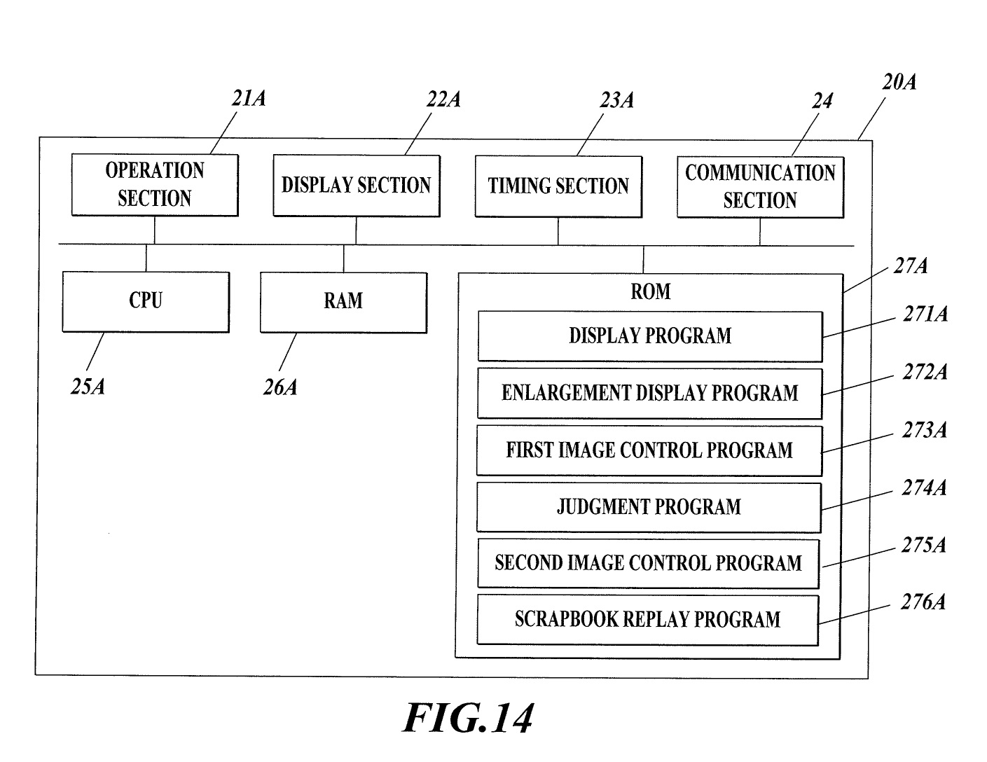

More specifically, as shown in FIG. 14, the user terminal 20A includes an operation section 21A, the display section 22A, a timing section 23A, the communication section 24, a CPU 25A, a RAM 26A, and a ROM 27A.

The operation section 21A is a touch panel disposed on the display section 22A, and a whole screen touch panel which is the so-called multi touch panel is used therefor, for example.

The display section 22A is composed of a LCD or the like, which is the same as the display section 22, and displays various screens such as a thumbnail screen G5 and an enlargement screen G6 which is changed from the thumbnail screen G5 so as to be displayed.

The thumbnail screen G5 is a screen on which the image of the first page of the sample image of a book content distributed from the content server 10 in response to the book content search request is displayed as a thumbnail.

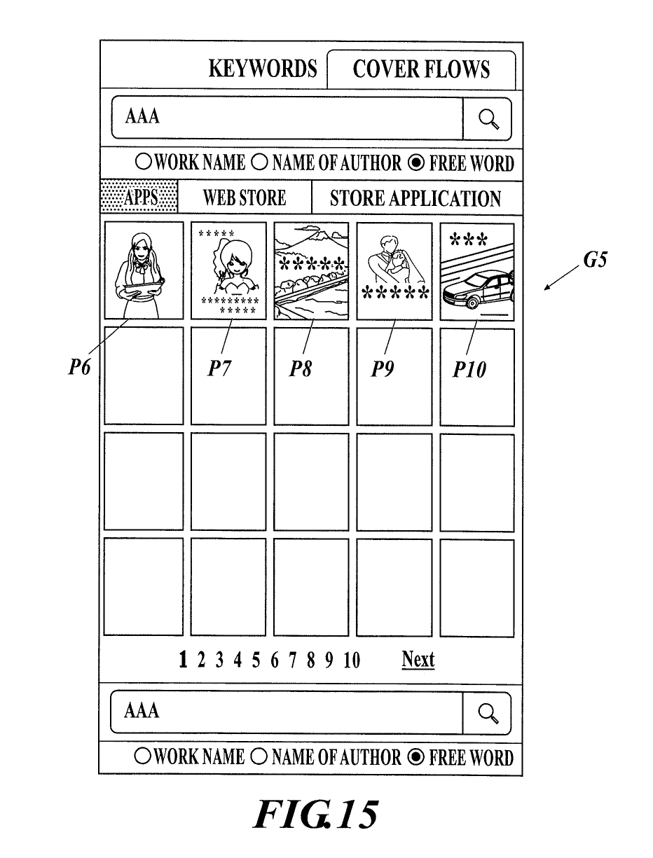

More specifically, as shown in FIG. 15, for example, 20 frames are disposed on the thumbnail screen G5 so that thumbnails of 20 book contents are displayed at the maximum. Thereby, the first page (front page) of the sample image of each book content distributed from the content server 10 is displayed as a thumbnail in a frame. When the number of the book contents distributed from the content server 10 is less than 20, the surplus frames are displayed without thumbnails therein. On the other hand, when the number of the book contents distributed from the content server 10 is more than 20, the thumbnail screen G5 having a plurality of screen pages changes its screen page from the currently displayed screen page to its next screen page.

FIG. 15 shows an example of sample images P6 to P10 of five book contents displayed as thumbnails.

When a user selects a thumbnail displayed on the thumbnail screen G5 by tapping the thumbnail with a finger, the thumbnail screen G5 is changed to the enlargement screen G6.

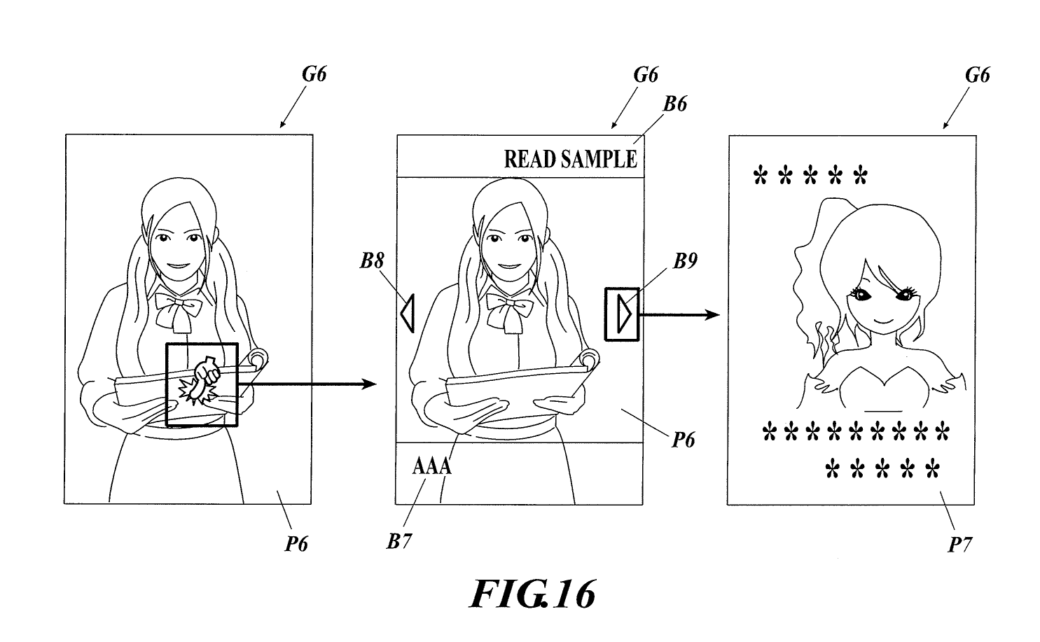

As shown in FIG. 16, when the enlargement screen G6 is tapped by the user with a finger, additional operation menus B6 and B7 are displayed on the top end part and the bottom end part of the enlargement screen G6, respectively. When the enlargement screen G6 is tapped again, the operation menus B6 and B7 are hidden.

At the left end part and the right end part on the enlargement screen G6, there are disposed sample image changing buttons B8 and B9 which respectively change the sample image displayed on the enlargement screen G6 to its previous sample image and its next sample image which are displayed on the thumbnail screen G5. By operating the sample image changing buttons B8 and B9, the sample image on the enlargement screen G6 can be changed to the previous sample image and the next sample image, respectively.

FIG. 16 shows a case where the operation menus B6 and B7 and the sample image changing buttons B8 and B9 are displayed on the enlargement screen G6 by tapping the enlargement screen G6 on which the enlarged image P6 is displayed, and the image P6 is changed to the image P7 by operating the sample image changing button B9.

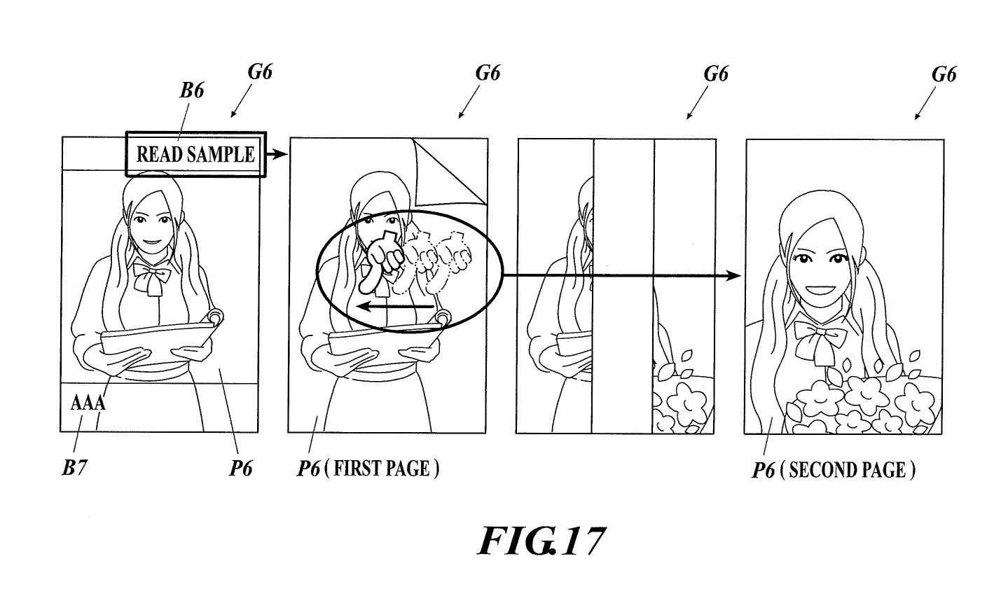

When the operation menu B6 is operated, as shown in FIG. 17, the right-top corner part of the image displayed on the enlargement screen G6 is flapped. When the user drags the image with a finger as the page-turning operation instruction, the next page gradually appears.

FIG. 17 shows a case where the first (front) page of the image is tuned, and accordingly the second page thereof in which the contents of its book are described appears.

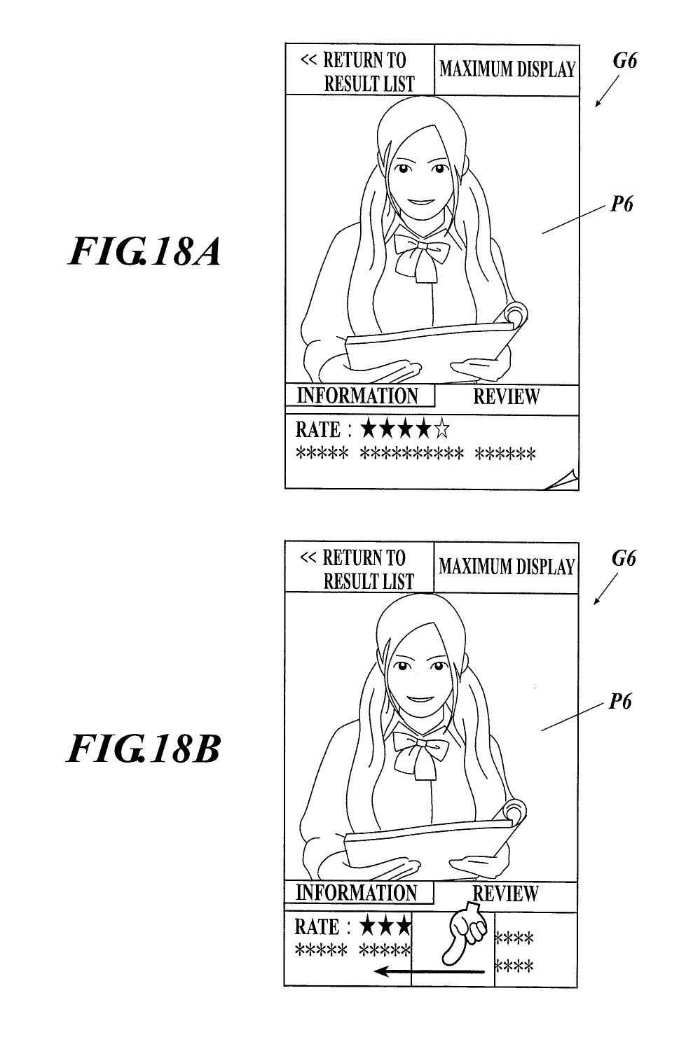

When the image of a secondary content is displayed on the enlargement screen G6 (FIG. 18A), and the page-turning operation instruction is provided to the image of the secondary content, pages of the image of the secondary content to which the page-turning operation instruction is provided are also turned page by page on the enlargement screen G6 (FIG. 18B).

The timing section 23A is a timer to measure a time from a time measurement starting point to a time measurement ending point based on a control signal from the CPU 11. The time measurement starting point is a time when the enlargement screen G6 is displayed on the display section 22A, and the time measurement ending point is a time when the user provides the page-turning operation instruction or when a preset prescribed period of time elapses.

The CPU 25A performs various control processing according to various processing programs stored in the ROM 27A, for example.

The RAM 26A forms a work memory area where data on which arithmetic processing is performed by the CPU 25A is stored.

The ROM 27A stores, for example, a display program 271A, an enlargement display program 272A, a first image control program 273A, a judgment program 274A, a second image control program 275A, and a scrapbook replay program 276A.

The display program 271A allows the CPU 25A to activate a function to display the thumbnail screen G5 on which the image of the first page of the sample image of a book content is displayed as a thumbnail based on the sample image data of the book content included in the search result information when the search result information distributed from the content server 10 in response to the book content search request is received, for example.

That is, in response to the search result information distributed from the content server 10, the CPU 25A displays the thumbnail screen G5 on the display section 22A by executing the display program 271A (FIG. 15).

The CPU 25A functions as the display unit with the display section 22A by executing the display program 271A.

The enlargement display program 272A allows the CPU 25A, when the user provides the enlargement instruction (tap operation) to the sample image of a book content displayed as a thumbnail on the thumbnail screen G5, to activate a function to display the enlargement screen G6 on which the sample image displayed as a thumbnail on the thumbnail screen G5 of the book content is enlarged so as to be displayed as an enlarged image, the sample image to which the enlargement instruction is provided, for example.

More specifically, the CPU 25A changes the thumbnail screen G5 to the enlargement screen G6 so as to display the enlargement screen G6 by executing the enlargement display program 272A (FIG. 16).

That is, in the embodiment, a part of the thumbnail screen G5, which is the search result screen, is enlarged and displayed, and the page-turning operation is performed thereon.

The CPU 25A functions as the enlargement display unit with the display section 22A by executing the enlargement display program 272A.

The first image control program 273A allows the CPU 25A to activate a function to turn pages of the sample image of a book content page by page on the enlargement screen G6, the sample image to which the page-turning operation instruction is provided, when the user provides the page-turning operation instruction to the sample image of the book content displayed as an enlarged image on the enlargement screen G6, for example.

More specifically, when the user provides the page-turning operation instruction to an enlarged image displayed on the enlargement screen G6, the CPU 25A executes the first image control program 273A, and thereby makes pages of the sample image displayed as the enlarged image turned page by page on the enlargement screen G6 (FIG. 17).

When the page-turning operation instruction is provided to the image of a secondary content, the CPU 25A also executes the first image control program 273A, and thereby makes pages of the image of the secondary content turned page by page on the enlargement screen G6, the image to which the page-turning operation instruction is provided (FIGS. 18A and 18B).

At this point, the CPU 25A communicates with the content server 10, and obtains the page information which is not obtained by the CPU 25A yet from the book content information 31 and/or the recommendation information 32 of the database 30.

The CPU 25A functions as the first image control unit by executing the first image control program 273A.

The judgment program 274A allows the CPU 25A to activate a function to judge whether the page-turning operation is instructed within a preset prescribed period of time since the enlargement screen G6 is displayed, for example.

More specifically, the CPU 25A allows the timing section 23A to measure a time from the time measurement starting point which is a time when the enlargement screen G6 is displayed on the display section 22A, and continues measuring the time unless the page-turning operation instruction is provided. When a preset prescribed period of time elapses before the page-turning operation instruction is provided, an instruction signal which instructs to automatically perform the page-turning operation is outputted.

The CPU 25A functions as the judgment unit by executing the judgment program 274A.

The second image control program 275A allows the CPU 25A to activate a function to turn pages of the sample image of a book content page by page on the enlargement screen G6 based on a preset condition when it is judged by executing the judgment program 274A that the page-turning operation instruction is not provided, for example.

That is, in response to an instruction signal which instructs to automatically perform the page-turning operation, the CPU 25A executes the second image control program 275A, and thereby performs the page-turning operation on the sample image of a book content on the enlargement screen G6 based on a preset condition (FIG. 17).

The CPU 25A functions as the second image control unit by executing the second image control program 275A.

The scrapbook replay program 276A allows the CPU 25A to activate a function to replay a scrapbook when the scrapbook distributed from the content server 10 in response to the scrapbook creation request is received, for example.

That is, when a scrapbook created at and distributed from the content server 10 in response to the scrapbook creation request is received, the CPU 25A executes the scrapbook replay program 276A, and thereby replays the scrapbook.

The CPU 25A functions as the scrapbook replay unit by executing the scrapbook replay program 276A.

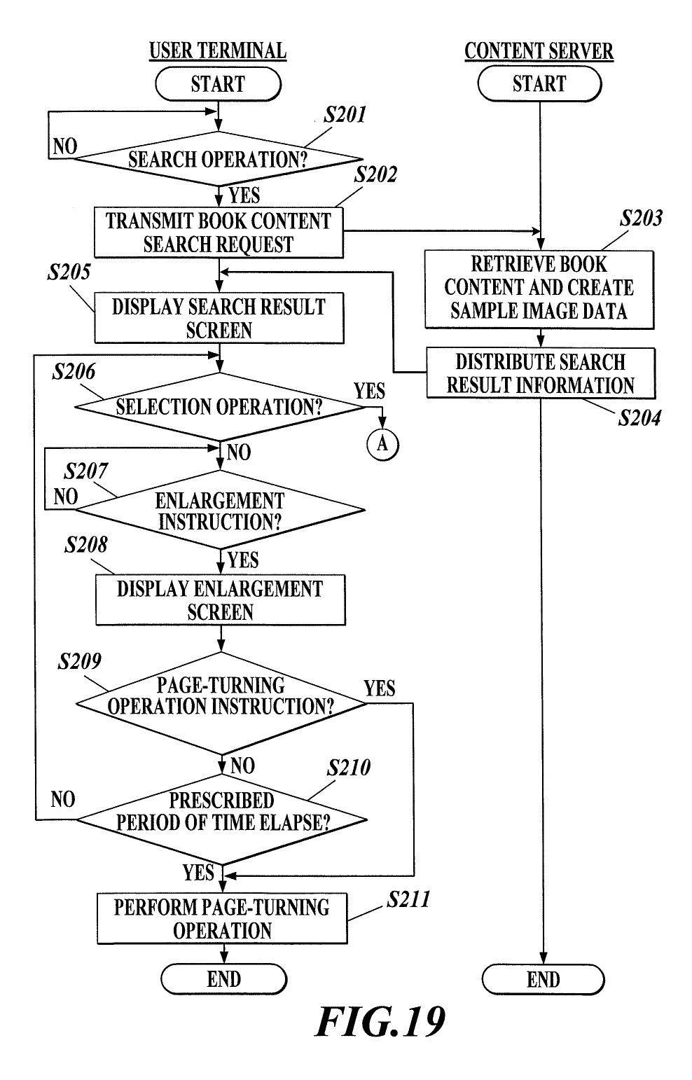

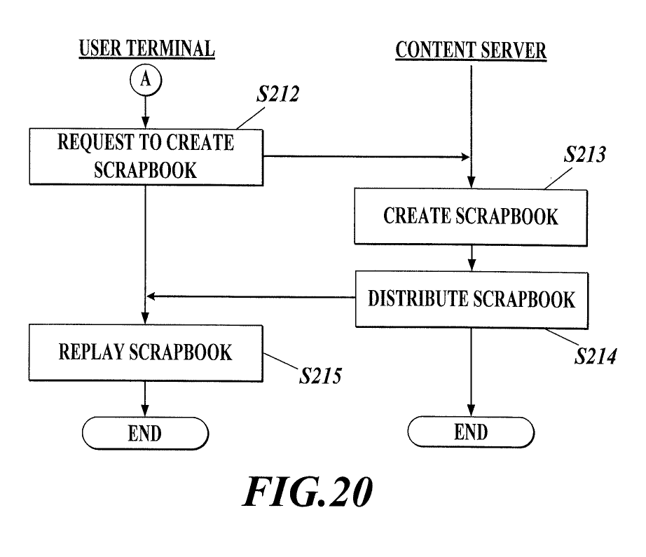

Next, an operation of the book content distribution system at the time of a book content search is described referring to FIGS. 19 and 20.

First, the CPU 25A of the user terminal 20A takes Steps S101 and S102 in the first embodiment as Steps S201 and S202, respectively, and the CPU 11 of the content server 10 takes Steps S103 and S104 in the first embodiment as Steps 203 and S204, respectively.

At Step S205, the CPU 25A of the user terminal 20A displays the thumbnail screen G5 on the display section 22A.

Next, at Step S206, the CPU 25A of the user terminal 20A judges whether the selection operation to select the sample images of book contents which are desired to be replayed as a batch is performed. When it is judged that the selection operation is performed (Step S206: YES), the CPU 25A moves to Step S212 described below.

On the other hand, when it is judged that the selection operation is not performed (Step S206: NO), the CPU 25A of the user terminal 20A judges whether the enlargement instruction is provided to a sample image from the operation section 21A at the following Step S207. When it is judged that the enlargement instruction is not provided (Step S207: NO), the CPU 25A repeats Step S207.

On the other hand, when it is judged that the enlargement instruction is provided (Step S207: YES), the CPU 25A of the user terminal 20A changes the thumbnail screen G5 to the enlargement screen G6 to display the enlargement screen G6.

Next, at Step S209, the CPU 25A of the user terminal 20A judges whether the page-turning operation instruction is provided from the operation section 21A. When it is judged that the page-turning operation instruction is provided (Step S209: YES), the CPU 25A moves to the Step S211 described below.

On the other hand, when it is judged that the page-turning operation instruction is not provided (Step S209: NO), the CPU 25A of the user terminal 20A judges whether the prescribed period of time elapses at the following Step S210. When it is judged that the prescribed period of time does not elapse (Step S210: NO), the CPU 25A returns to Step S206, and repeats the following steps.

On the other hand, when it is judged that the prescribed period of time elapses (Step S210: YES), the CPU 25A of the user terminal 20A moves to the following Step S211.

At Step S211, the CPU 25A of the user terminal 20A performs the page-turning operation.

Next, the CPU 25A of the user terminal 20A takes Steps S112 and S115 in the first embodiment as Steps S212 and S215, respectively, and the CPU 11 of the content server 10 takes Steps S113 and S114 in the first embodiment as Steps 213 and S214, respectively.

As described above, according to the embodiment, the user terminal 20A displays, when the search result information distributed from the content server 10 is received, the thumbnail screen G5 on which the image of the first page of the sample image of the book content is displayed as the thumbnail based on the sample image data of the book content included in the search result information, and, when a user provides the enlargement instruction to the sample image of the book content displayed on the thumbnail screen G5, displays the enlargement screen G6 on which the sample image of the book content is enlarged and displayed, the sample image to which the enlargement instruction is provided. Then, when the user provides the page-tuning operation instruction to the sample image enlarged and displayed on the enlargement screen G6, the user terminal 20A makes pages of the sample image of the book content turned page by page on the enlargement screen G6, the sample image to which the page-turning operation instruction is provided.

Accordingly, the pages of the sample image are turned on the enlargement screen G6 which is a part of the search result screen being enlarged, the search result screen on which the book contents obtained as a search result are displayed. Consequently, without moving from the enlargement screen G6, the contents of its book can be looked at, and detailed information on the book content can be obtained.

In the embodiment too, each of the thumbnail screen G5 and the enlargement screen G6 is displayed so as to cover almost the whole surface of the display section 22A. However, each of the thumbnail screen G5 and the enlargement screen G6 may be displayed on a part of the surface of the display section 22A.

In such a manner, the book content distribution system can be used for a web widget, search advertising, and contexual advertising, for example.

The detailed structure of the present invention is not limited to the first and the second embodiments described above, and hence can be appropriately modified without departing from the scope of the present invention.

The present invention is applicable to the field of information communications, for example.

What is claimed is:

1-6. (canceled)

7. A book content distribution system comprising:
a content server; and
a user terminal connected with the content server via a communication network,
the content server including:
a search database from which a book content is retrieved;
a search unit to retrieve the book content from the search database in response to a book content search request, the book content meeting the book content search request transmitted from the user terminal;
a sample image data creation unit to create sample image data having a plurality of pages, with regard to the book content retrieved by the search unit; and
a search result information distribution unit to distribute search result information to the user terminal, the search result information including the sample image data created by the sample image data creation unit, and
the user terminal including:
a display unit to display, when the search result information distributed from the content server in response to the book content search request is received, a thumbnail screen on which an image of a first page of a sample image of the book content is displayed as a thumbnail based on the sample image data of the book content included in the search result information; and
a first image control unit to make, when a user provides a page-turning operation instruction to the sample image of the book content displayed on the thumbnail screen as the thumbnail, pages of the sample image of the book content turned page by page on the thumbnail screen, the sample image to which the page-turning operation instruction is provided.

8. The book content distribution system according to claim 7, wherein
the user terminal further includes an enlargement display unit to display, when the user provides an enlargement instruction to the sample image of the book content displayed on the thumbnail screen as the thumbnail, an enlargement screen on which the sample image of the book content is enlarged and displayed, the sample image to which the enlargement instruction is provided, and
when the user provides the page-turning operation instruction to the sample image of the book content enlarged and displayed on the enlargement screen, the first image control unit makes pages of the sample image of the book content turned page by page on the enlargement screen, the sample image to which the page-turning operation instruction is provided.

9. The book content distribution system according to claim 8, wherein the user terminal further includes:
a judgment unit to judge whether the page-turning operation instruction is provided within a preset prescribed period of time since the thumbnail screen or the enlargement screen is displayed; and
a second image control unit to make the pages of the sample image of the book content turned page by page on the thumbnail screen or the enlargement screen based on a preset condition, when the page-turning operation instruction is not provided within the preset prescribed period of time.

10. The book content distribution system according to claim 8, wherein
the sample image data creation unit attaches a secondary content related to the book content, which is retrieved by the search unit, as attachment information to the sample image data, and
when the page-turning operation instruction is provided to an image of the secondary content, the image which is based on the attachment information, the first image control unit makes pages of the image of the secondary content turned page by page on the thumbnail screen or the enlargement screen, the image to which the page-turning operation instruction is provided.

11. The book content distribution system according to claim 7, wherein
the content server further includes:
a scrapbook creation unit to create a scrapbook of a plurality of the book contents in response to a scrapbook creation request transmitted from the user terminal, the scrapbook creation request requesting to create the scrapbook for sequentially replaying the sample images of the book contents as a batch; and
a scrapbook distribution unit to distribute the scrapbook of the book contents to the user terminal, the scrapbook being created by the scrapbook creation unit, and
the user terminal further includes:
a scrapbook replay unit to replay the scrapbook when the scrapbook is received, the scrapbook being distributed from the content server in response to the scrapbook creation request.

12. A content server connected with a user terminal via a communication network, the content server comprising:
a search database from which a book content is retrieved;
a search unit to retrieve a book content from the search database in response to a book content search request, the book content meeting the book content search request transmitted from the user terminal;
a sample image data creation unit to create sample image data having a plurality of pages, with regard to the book content retrieved by the search unit; and
a search result information distribution unit to distribute search result information to the user terminal, the search result information including the sample image data created by the sample image data creation unit.

13. The book content distribution system according to claim 8, wherein the content server further includes:
a scrapbook creation unit to create a scrapbook of a plurality of the book contents in response to a scrapbook creation request transmitted from the user terminal, the scrapbook creation request requesting to create the scrapbook for sequentially replaying the sample images of the book contents as a batch; and
a scrapbook distribution unit to distribute the scrapbook of the book contents to the user terminal, the scrapbook being created by the scrapbook creation unit, and
the user terminal further includes:
a scrapbook replay unit to replay the scrapbook when the scrapbook is received, the scrapbook being distributed from the content server in response to the scrapbook creation request.

14. The book content distribution system according to claim 9, wherein
the content server further includes:
a scrapbook creation unit to create a scrapbook of a plurality of the book contents in response to a scrapbook creation request transmitted from the user terminal, the scrapbook creation request requesting to create the scrapbook for sequentially replaying the sample images of the book contents as a batch; and
a scrapbook distribution unit to distribute the scrapbook of the book contents to the user terminal, the scrapbook being created by the scrapbook creation unit, and
the user terminal further includes:
a scrapbook replay unit to replay the scrapbook when the scrapbook is received, the scrapbook being distributed from the content server in response to the scrapbook creation request.

15. The book content distribution system according to claim 10, wherein
the content server further includes:
a scrapbook creation unit to create a scrapbook of a plurality of the book contents in response to a scrapbook creation request transmitted from the user terminal, the scrapbook creation request requesting to create the scrapbook for sequentially replaying the sample images of the book contents as a batch; and
a scrapbook distribution unit to distribute the scrapbook of the book contents to the user terminal, the scrapbook being created by the scrapbook creation unit, and
the user terminal further includes:
a scrapbook replay unit to replay the scrapbook when the scrapbook is received, the scrapbook being distributed from the content server in response to the scrapbook creation request.
